(19) United States
(12) Patent Application Publication
(10) Pub. No.: US 2016/0176342 A1
(43) Pub. Date: Jun. 23, 2016

(54) VEHICLE-REVERSING DISPLAY SYSTEM CAPABLE OF AUTOMATICALLY SWITCHING MULTIPLE FIELD-OF-VIEW MODES AND VEHICLE-REVERSING IMAGE CAPTURE DEVICE

(71) Applicant: Seeways Technology Inc., Taipei City (TW)

(72) Inventors: Tung-Shin Yang, Taipei City (TW); Hsun-Tao Cho, Taipei City (TW); Ho-Kang Huang, Taipei City (TW); Chen-Kuo Hsu, Taipei City (TW); Minghua Lin, Taipei City (TW)

(21) Appl. No.: 14/836,670

(22) Filed: Aug. 26, 2015

(30) Foreign Application Priority Data
Dec. 18, 2014 (TW) 103222468

(51) Int. Cl. B60R 1/00; B60R 11/04; H04N 7/18

(52) U.S. Cl. CPC B60R 1/00; H04N 7/181; B60R 11/04; B60R 2300/404; B60R 2300/802

(57) ABSTRACT

A vehicle-reversing display system includes a controller area network, a vehicle-reversing image capture device and a display device. The vehicle-reversing image capture device includes a controlling unit, a first image camera unit and a second image camera unit. The first image camera unit includes a first camera control unit and a first sensor. The second image camera unit includes a second camera control unit and a second sensor. The controlling unit judges a driving scenario according to vehicle-reversing parameters from the controller area network. The first image camera unit and the second image camera unit are automatically enabled or disabled according to the driving scenario. The first image camera unit and the second image camera unit are automatically operated in a wide field-of-view mode, a normal field-of-view mode, or a top field-of-view mode under control of the first camera control unit and the second camera control unit according to a first distance from a first obstacle and a second distance from a second obstacle.

### FIELD OF THE INVENTION

The present invention relates to a vehicle-reversing display system, and more particularly to a vehicle-reversing display system capable of automatically switching multiple field-of-view modes by image object detection and a vehicle-reversing image capture device thereof.

### BACKGROUND OF THE INVENTION

With the improving development of the transmission system and the materials science and the economic growth, vehicles have high flexibility and popularity. Consequently, the users spend less time going to their destinations. As the number of the vehicle users gradually increases, vehicle safety is getting more and more important.

Conventionally, the vehicle safety techniques are aimed at the improvements about the field of view (FOV) of the travelling vehicle and the safety distance between a specified vehicle and the vehicles at the front side, rear side, left side, or right side of the specified vehicle. Moreover, the researches about the auxiliary vehicle-reversing devices were published. With the enhancement of safety awareness, ultrasonic sensors or vehicle-reversing camera are widely applied to the current auxiliary vehicle-reversing devices. Generally, when a sound wave reflected from an obstacle is detected by the ultrasonic sensor, a warning sound is generated. However, the effective echo depth of the conventional ultrasonic sensor is at most 90-150 centimeters. Moreover, if the detecting height is lower than 30-45 centimeters, the conventional ultrasonic sensor is unable to effectively detect the obstacle. Moreover, since the width of the ultrasonic sensor is fan-shaped, a blind zone is formed behind the vehicle. In case that an obstacle is in the blind zone, the echo depth, the detecting height and the detecting width are undetectable. Moreover, when the obstacle behind the vehicle is sensed by the ultrasonic sensor, only the warning sound is generated to notify the driver. However, since the driver cannot realize the distance or the position of the obstacle through the ultrasonic sensor, the driver cannot realize the real situation behind the vehicle by the ultrasonic sensor.

Nowadays, a conventional vehicle-reversing camera and an ultrasonic sensor are collaboratively used to display the scene behind the vehicle. However, since the horizontal viewing angle of the conventional vehicle-reversing camera is at most 140 to 150 degrees, the narrow viewing angle may result in a blind zone. Moreover, the field of view of the conventional vehicle-reversing camera cannot be automatically adjusted. Consequently, if the vehicle is close to an object with a vertical plane, the possibility of causing collision or accident increases because the conventional vehicle-reversing camera cannot capture the image of the scene from the top field of view. For example, if a ravine, a cliff, a harbor embankment or any other object with the vertical plane is behind a vehicle, the driver cannot judge the real situation behind the vehicle because the image cannot be captured from the top field of view. Consequently, the rear wheels possibly fell into the ravine or the cliff, or collide with the harbor embankment.

Moreover, the operating mode of the conventional vehicle-reversing camera includes a wide field-of-view mode, a normal field-of-view mode or a top field-of-view mode. However, for acquiring the appropriate FOV, the operating mode is selected by the driver. However, it is not convenient for the user to switch the operating mode because the action of reversing the vehicle has to be continuously done.

Therefore, there is a need of providing an improved vehicle-reversing display system and an improved vehicle-reversing image capture device in order to overcome the above drawbacks.

### SUMMARY OF THE INVENTION

An object of the present invention provides a vehicle-reversing display system and a vehicle-reversing image capture device capable of automatically switching the operating mode of a vehicle-reversing image capture device according to the distance of a front obstacle and a rear obstacle from the vehicle. As a consequence, an auxiliary image corresponding to a wide field-of-view mode, a normal field-of-view mode, or a top field-of-view mode is displayed on a display device. According to the auxiliary image, the driver can realize the real situation behind the vehicle while reversing the vehicle.

Another object of the present invention provides a vehicle-reversing display system and a vehicle-reversing image capture device capable of determining the timing of enabling a front image camera unit and a rear image camera unit according to vehicle operating parameters (e.g., a gear shift changing information and a gear shift retention time period).

In accordance with an aspect of the present invention, there is provided a vehicle-reversing display system capable of automatically switching multiple field-of-view modes by image object detection. The vehicle-reversing display system includes a controller area network, a vehicle-reversing image capture device and a display device. The controller area network provides plural vehicle-reversing parameters. The vehicle-reversing image capture device includes a first image camera unit, a second image camera unit and a controlling unit. The first image camera unit includes a first camera control unit and a first sensor, wherein the first sensor captures image and the first camera control unit recognizes a first distance between the first image camera unit and a first obstacle. The second image camera unit includes a second camera control unit and a second sensor, wherein the second sensor captures image and the second camera control unit recognizes a second distance between the second image camera unit and a second obstacle. The first image camera unit and the second image camera unit are automatically operated in a wide field-of-view mode, a normal field-of-view mode, or a top field-of-view mode under control of the first camera control unit and the second camera control unit according to the first distance and the second distance, respectively. The controlling unit is connected with the first image camera unit, the second image camera unit and the controller area network. The controlling unit judges a driving scenario of a vehicle according to the plural vehicle-reversing parameters from the controller area network. The first image camera unit and the second image camera unit are automatically and selectively enabled or disabled according to the driving scenario. The display device is connected with the vehicle-reversing image capture device and the controller area network. An auxiliary image corresponding to the wide field-of-view mode, the normal field-of-view mode, or the top field-of-view mode is captured by the first image camera unit or the second image camera unit and displayed on the display device.

In accordance with another aspect of the present invention, there is provided a vehicle-reversing image capture device of a vehicle-reversing display system capable of automatically switching multiple field-of-view modes by image object detection. The vehicle-reversing display system includes a controller area network, a display device, and the vehicle-reversing image capture device. The vehicle-reversing image capture device includes a first image camera unit, a second image camera unit and a controlling unit. The first image camera unit includes a first camera control unit and a first sensor, wherein the first sensor captures image and the first camera control unit recognizes a first distance between the first image camera unit and a first obstacle. The second image camera unit includes a second camera control unit and a second sensor, wherein the second sensor captures image and the second camera control unit recognizes a second distance between the second image camera unit and a second obstacle. The first image camera unit and the second image camera unit are automatically and selectively enabled or disabled according to a driving scenario. The first image camera unit and the second image camera unit are automatically operated in a wide field-of-view mode, a normal field-of-view mode, or a top field-of-view mode under control of the first camera control unit and the second camera control unit according to the first distance and the second distance, respectively. The controlling unit is connected with the first image camera unit, the second image camera unit, and the controller area network. The controlling unit judges the driving scenario of a vehicle according to the plural vehicle-reversing parameters from the controller area network. An auxiliary image corresponding to the wide field-of-view mode, the normal field-of-view mode, or the top field-of-view mode is captured by the first image camera unit or the second image camera unit and displayed on the display device.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a vehicle-reversing display system according to an embodiment of the present invention;

FIG. 2 schematic illustrates the relationship between the vehicle, a front obstacle and a rear obstacle;

FIG. 3A schematically illustrates an auxiliary image captured by the second image camera unit of the vehicle-reversing image capture device in the wide field-of-view mode according to the embodiment of the present invention;

FIG. 3B schematically illustrates an auxiliary image captured by the second image camera unit of the vehicle-reversing image capture device in the normal field-of-view mode according to the embodiment of the present invention; and

FIG. 3C schematically illustrates an auxiliary image captured by the second image camera unit of the vehicle-reversing image capture device in the top field-of-view mode according to the embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

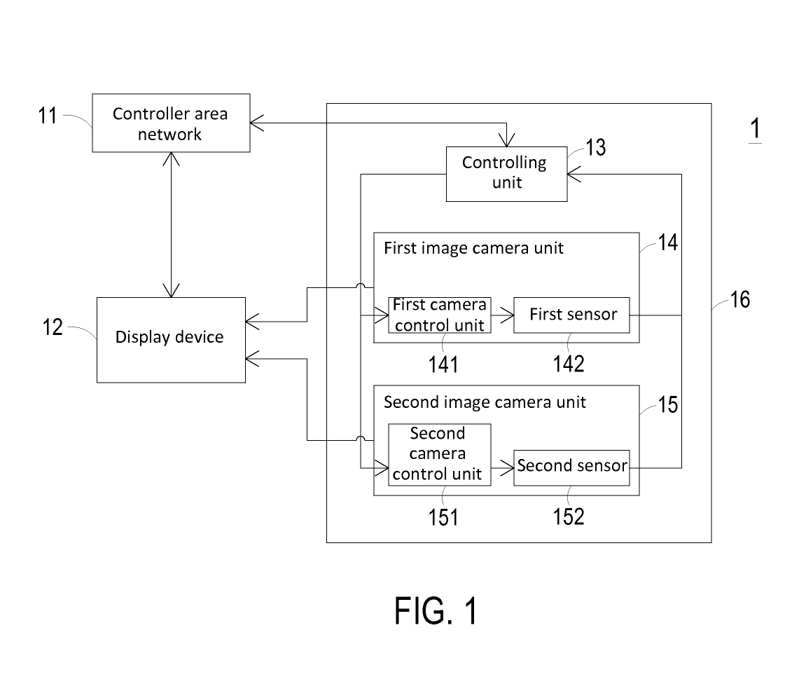

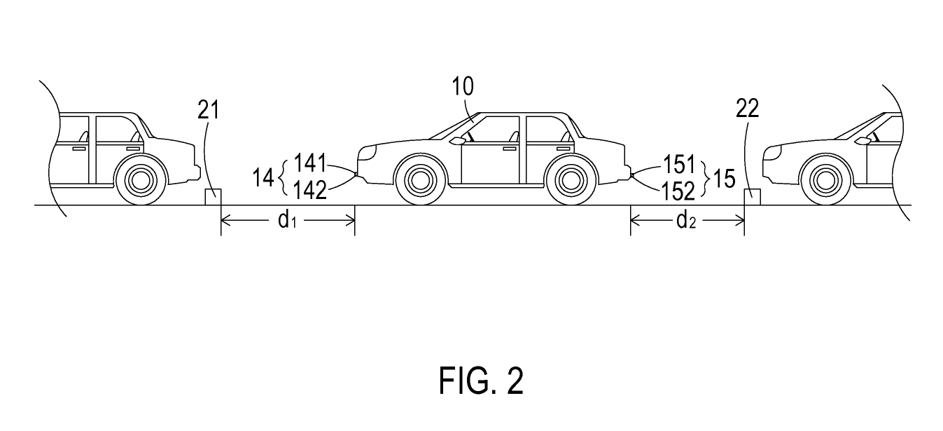

FIG. 1 is a schematic functional block diagram illustrating a vehicle-reversing display system according to an embodiment of the present invention. The vehicle-reversing display system 1 is applied to a vehicle 10 (see FIG. 2). The vehicle-reversing display system 1 comprises a controller area network (also referred as a CAN Bus) 11, a display device 12, and a vehicle-reversing image capture device 16. The controller area network 11 is connected with a vehicular computer (not shown). The vehicular computer is installed in the vehicle 10 for providing plural vehicle operating parameters. The plural vehicle operating parameters indicate the current operating statuses of the vehicle 10. For example, the plural vehicle operating parameters include a vehicle power parameter, an engine status parameter, a vehicle speed parameter, a gear shift changing information, a gear shift retention time period, and so on. In the following embodiments, the gear shift changing information and the gear shift retention time period are taken as the examples of the vehicle operating parameters. It is noted that the examples of the vehicle operating parameters are not restricted.

Please refer to FIG. 1 again. The vehicle-reversing image capture device 16 comprises a controlling unit 13, a first image camera unit 14 and a second image camera unit 15. The controlling unit 13 is connected with the controller area network 11. The first image camera unit 14 is connected with the controlling unit 13 and the display device 12, and comprises a first camera control unit 141 and a first sensor 142. The second image camera unit 15 is connected with the controlling unit 13 and the display device 12, and comprises a second camera control unit 151 and a second sensor 152. The first image camera unit 14 is located at a front side of the vehicle 10 (see FIG. 2). The first image camera unit 14 is used for capturing a scene in front of the vehicle 10. The installation location of the first image camera unit 14 is not restricted as long as the scene in front of the vehicle 10 can be captured by the first image camera unit 14. The second image camera unit 15 is located at a rear side of the vehicle 10 (see FIG. 2). The second image camera unit 15 is used for capturing a scene behind the vehicle 10. The installation location of the second image camera unit 15 is not restricted as long as the scene behind the vehicle 10 can be captured by the second image camera unit 15. The first sensor 142 of the first image camera unit 14 is used for capturing a first image, and the first camera control unit 141 of the first image camera unit 14 is used for detecting a first distance d1 of a first obstacle 21 from the first image camera unit 14. The second sensor 152 of the second image camera unit 15 is used for capturing a second image and the second camera control unit 151 of the second image camera unit 15 is used for detecting a second distance d2 of a second obstacle 22 from the second image camera unit 15. It is noted that the types of the first image camera unit 14 and the second image camera unit 15 are not restricted. Examples of the first image camera unit 14 and the second image camera unit 15 include but are not limited to ordinary cameras, wide-angle cameras, or fisheye cameras (i.e., ultra wide-angle cameras). The display device 12 is installed in the vehicle 10 and connected with the vehicle-reversing image capture device 16. After the vehicle-reversing parameters of the controller area network 11 are acquired by the controlling unit 13 of the vehicle-reversing image capture device 16, the controlling unit 13 judges the driving scenario of the vehicle 10. According to the driving scenario of the vehicle 10, the first image camera unit 14 and the second image camera unit 15 are selectively enabled or disabled. Moreover, according to the first distance d1 and the second distance d2, the first image camera unit 14 and the second image camera unit 15 are automatically switched to a wide field-of-view mode, a normal field-of-view mode, or a top field-of-view mode. Consequently, an auxiliary image corresponding to the wide field-of-view mode, the normal field-of-view mode, or the top field-of-view mode is displayed on the display device 12.

Please refer to FIG. 1 again. The controlling unit 13 can acquire the vehicle-reversing parameters from the controller area network 11. In this embodiment, the vehicle operating parameters includes the gear shift changing information and the gear shift retention time period. According to the gear shift changing information and the gear shift retention time period, the controlling unit 13 judges whether the driving scenario of the vehicle 10 is a first scenario, a second scenario, or a third scenario. For example, if the gear shift changing information indicates that the gear shift of the vehicle 10 is changed from a non-reverse gear shift to a reverse gear shift, the controlling unit 13 judges that the driving scenario of the vehicle 10 is the first scenario. Meanwhile, the first image camera unit 14 and the second image camera unit 15 are both enabled. Whereas, if the gear shift changing information indicates that the gear shift of the vehicle 10 is changed from the reverse gear shift to the non-reverse gear shift, the controlling unit 13 judges that the driving scenario of the vehicle 10 is the second scenario. Meanwhile, the first image camera unit 14 is enabled, but the second image camera unit 15 is disabled. Whereas, if the gear shift changing information indicates that the gear shift of the vehicle 10 is changed from the reverse gear shift to the non-reverse gear shift and the gear shift retention time period exceeds a threshold time (e.g., 15 seconds), the controlling unit 13 judges that the driving scenario of the vehicle 10 is the third scenario. Meanwhile, the first image camera unit 14 and the second image camera unit 15 are both disabled.

In case that the gear shift information of the vehicle 10 is the reverse gear shift, the controlling unit 13 judges that the driving scenario of the vehicle 10 is the first scenario. Meanwhile, the first image camera unit 14 and the second image camera unit 15 are both enabled, so that the FOV in front of the vehicle 10 and the FOV behind the vehicle 10 can be observed by the driver. When the vehicle 10 is reversed to a proper position, the driver may change the reverse gear shift to a parking gear shift (i.e., a non-reverse gear shift). After the parking process of the vehicle 10 is completed, the controlling unit 13 judges that the driving scenario of the vehicle 10 is the second scenario. Meanwhile, the second image camera unit 15 is disabled. If the parking position of the vehicle 10 is not proper, the driver may change the gear shift in a short time in order to slightly adjust the parking position. As mentioned above, the third scenario is realized when the gear shift of the vehicle 10 is changed from the reverse gear shift to the non-reverse gear shift and the gear shift retention time period exceeds the threshold time. Since the driver repeatedly change the gear shift in the short time in order to slightly adjust the parking position, the controlling unit 13 judges that the driving scenario of the vehicle 10 is switched between the first scenario and the second scenario. Under this circumstance, the first image camera unit 14 is continuously enabled, but the second image camera unit 15 is automatically enabled only when the vehicle 10 is reversed. Consequently, while the parking position of the vehicle 10 is adjusted, the driver can continuously notice the distances from the front obstacle and the rear obstacle.

Generally, the front image camera unit of the conventional vehicle-reversing image capture device is enabled according to the gear shift and the speed of the vehicle. For example, if the vehicle is in a forward gear shift at a slow speed, the front image camera unit is enabled. The timing of enabling the front image camera unit has some drawbacks. For example, when the vehicle travelling in an urban road encounters traffic congestion, the vehicle is usually in a forward gear shift at a slow speed (e.g., 5˜10 kilometer/hr) and thus the front camera is enabled. As known, it is not the right time to enable the front camera. According to the technology of the present invention, the first image camera unit 14 is enabled when the gear shift of the vehicle 10 is changed from the non-reverse gear shift to the reverse gear shift or changed from the reverse gear shift to the non-reverse gear shift. Since the vehicle 10 is usually not in the reverse gear shift when encountering traffic congestion, the first image camera unit 14 is not enabled according to the technology of the present invention.

FIG. 2 schematic illustrates the relationship between the vehicle, a front obstacle and a rear obstacle. As shown in FIG. 2, the distance between the first image camera unit 14 and the first obstacle 21 is the first distance d1, and the distance between the second image camera unit 15 and the second obstacle 22 is the second distance d2. The first sensor 142 of the first image camera unit 14 and the second sensor 152 of the second image camera unit 15 can capture the image, and the first camera control unit 141 of the first image camera unit 14 and the second camera control unit 151 of the second image camera unit 15 recognize the values of the first distance d1 and the second distance d2, and provide the values of the first distance d1 and the second distance d2 to the controlling unit 13. Moreover, the operating modes of the first image camera unit 14 and the second image camera unit 15 are automatically adjusted by the first camera control unit 141 of the first image camera unit 14 and the second camera control unit 151 of the second image camera unit 15 according to the first distance d1 and the second distance d2. For example, if the first distance d1 (or the second distance d2) is a longer distance (e.g., longer than 1.5 m), the first image camera unit 14 (or the second image camera unit 15) is automatically switched to a wide field-of-view mode under control of the first camera control unit 141 (or the second camera control unit 151). If the first distance d1 (or the second distance d2) is a medium distance (e.g., in the range between 0.4 m and 1.5 m), the first image camera unit 14 (or the second image camera unit 15) is automatically switched to a normal field-of-view mode under control of the first camera control unit 141 (or the second camera control unit 151). If the first distance d1 (or the second distance d2) is a shorter distance (e.g., shorter than 0.4 m), the first image camera unit 14 (or the second image camera unit 15) is automatically switched to a top field-of-view mode under control of the first camera control unit 141 (or the second camera control unit 151). Consequently, an auxiliary image corresponding to the wide field-of-view mode, the normal field-of-view mode, or the top field-of-view mode is displayed on the display device 12. Since the operating modes of the first image camera unit 14 and the second image camera unit 15 are automatically adjusted by the first camera control unit 141 (or the second camera control unit 151), the vehicle-reversing image capture device 16 of the present invention is more user-friendly.

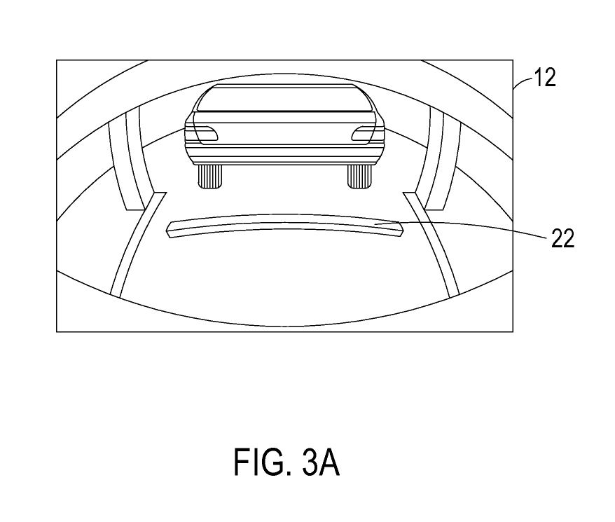

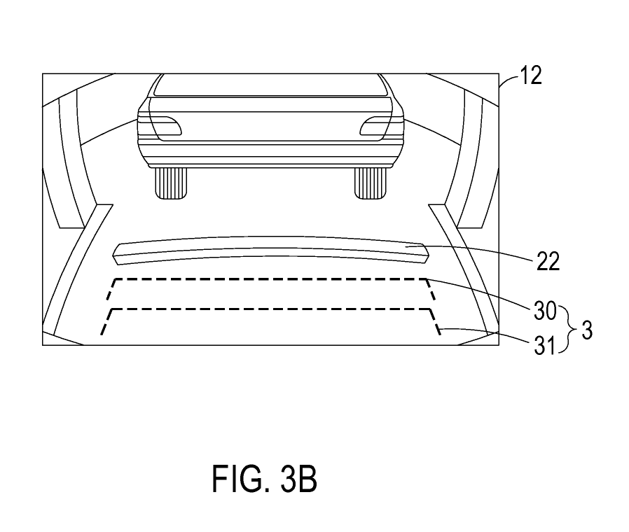

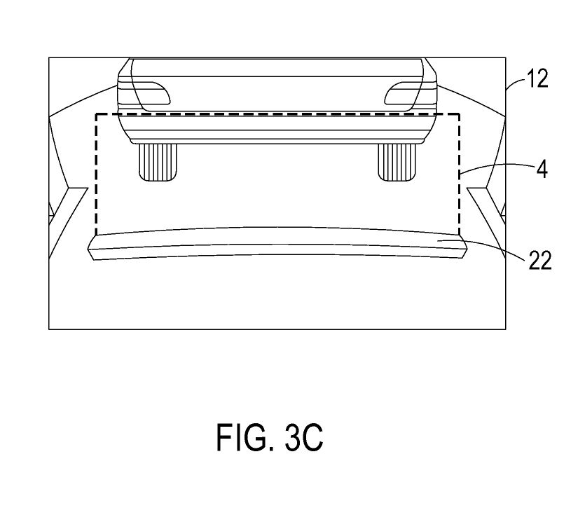

FIG. 3A schematically illustrates an auxiliary image captured by the second image camera unit of the vehicle-reversing image capture device in the wide field-of-view mode according to the embodiment of the present invention. Please refer to FIGS. 2 and 3A. After the vehicle-reversing parameters of the controller area network 11 are acquired by the controlling unit 13 of the vehicle-reversing image capture device 16, the controlling unit 13 realizes that the gear shift of the vehicle 10 is changed from the non-reverse gear shift to the reverse gear shift and judges that the driving scenario of the vehicle 10 is the first scenario. Meanwhile, the first image camera unit 14 and the second image camera unit 15 are both enabled. In addition, the first sensor 142 of the first image camera unit 14 and the second sensor 152 of the second image camera unit 15 capture the image, and the first camera control unit 141 of the first image camera unit 14 and the second camera control unit 151 of the second image camera unit 15 recognize the values of the first distance d1 and the second distance d2. For example, the second distance d2 is longer than 1.5 m. Consequently, the second image camera unit 15 is automatically switched to the wide field-of-view mode under control of the second camera control unit 151. Moreover, as shown in FIG. 3A, the auxiliary image corresponding to the wide field-of-view mode is displayed on the display device 12. Through the auxiliary image corresponding to the wide field-of-view mode, the driver can realize the distance of the second obstacle 22 and the scene behind the vehicle 10. That is, the auxiliary image can assist the driver to start reversing the vehicle 10. The operations of the first image camera unit 14 are similar to those of the second image camera unit 15. According to the first distance d1 between the first image camera unit 14 and the first obstacle 21 which is captured by the first sensor 142 and recognized by the first camera control unit 141, the operating mode of the first image camera unit 14 is automatically adjusted by the first camera control unit 141. Through the auxiliary image corresponding to the operating mode of the first image camera unit 14, the driver can realize the distance of the front first obstacle 21 and the scene in front of the vehicle 10. Preferably but not exclusively, the horizontal viewing angle of the first image camera unit 14 (or the second image camera unit 15) in the wide field-of-view mode is in the range between 170 and 190 degrees.

FIG. 3B schematically illustrates an auxiliary image captured by the second image camera unit of the vehicle-reversing image capture device in the normal field-of-view mode according to the embodiment of the present invention. Please refer to FIGS. 2 and 3B. For example, if the second sensor 152 of the second image camera unit 15 captures the image and the second camera control unit 151 of the second image camera unit 15 recognizes that the second distance d2 between the second image camera unit 15 and the second obstacle 22 is the medium distance (e.g., in the range between 0.4 m and 1.5 m), the second image camera unit 15 is automatically switched to the normal field-of-view mode under control of the second camera control unit 151. Moreover, as shown in FIG. 3B, the auxiliary image corresponding to the normal field-of-view mode is displayed on the display device 12. Through the auxiliary image corresponding to the normal field-of-view mode, the driver can realize the distance of the second obstacle 22 and the scene behind the vehicle 10. That is, the auxiliary image can assist the driver to park the vehicle 10. Preferably but not exclusively, the horizontal viewing angle in the normal field-of-view mode is in the range between 110 and 150 degrees. Moreover, for further assisting the driver to reverse and park the vehicle 10, plural virtual parking lines 3 are contained in the auxiliary image corresponding to the normal field-of-view mode. As shown in FIG. 3B, two parking lines 30 and 31 are contained in the auxiliary image. It is noted that the number of parking lines is not restricted. According to the parking lines, the driver can estimate the distance of the vehicle 10 from the front obstacle 21 or the rear obstacle 22. Consequently, the possibility of causing collision will be minimized.

FIG. 3C schematically illustrates an auxiliary image captured by the second image camera unit of the vehicle-reversing image capture device in the top field-of-view mode according to the embodiment of the present invention. Please refer to FIGS. 2 and 3C. For example, if the second sensor 152 of the second image camera unit 15 captures the image and the second camera control unit 151 of the second image camera unit 15 recognizes that the second distance d2 between the second image camera unit 15 and the second obstacle 22 is the shorter distance (e.g., shorter than 0.4 m), the second image camera unit 15 is automatically switched to the top field-of-view mode under control of the second camera control unit 151. Consequently, as shown in FIG. 3C, the auxiliary image corresponding to the top field-of-view mode is displayed on the display device 12. Through the auxiliary image corresponding to the normal field-of-view mode, the driver can realize the distance of the second obstacle 22 and the scene behind the vehicle 10. Consequently, even if the field of view corresponding to the shorter distance in the vertical direction is impaired, the possibility of causing collision or accident will be minimized. Preferably but not exclusively, the horizontal viewing angle in the top field-of-view mode is in the range between 60 and 90 degrees. Moreover, for further assisting the driver to reverse and park the vehicle 10, a vertical virtual parking mark 4 (e.g., an inverted U-shaped virtual parking mark) is contained in the auxiliary image corresponding to the top field-of-view mode. According to the parking line, the driver can estimate the distance of the vehicle 10 from the front obstacle 21 or the rear obstacle 22. Through the auxiliary image corresponding to the top field-of-view mode, the driver can realize the condition of the floor behind the vehicle 10. Consequently, the possibility of causing collision or accident will be minimized.

From the above descriptions, the present invention provides a vehicle-reversing display system capable of automatically switching multiple field-of-view modes by image object detection. The vehicle-reversing display system includes a controller area network, a display device and a vehicle-reversing image capture device. The vehicle-reversing image capture device comprises a controlling unit, a first image camera unit and a second image camera unit. A first sensor of the first image camera unit and the second sensor of the second image camera unit can capture the image, and the first camera control unit of the first image camera unit and the second camera control unit of the second image camera unit recognize a first distance between the vehicle and a front obstacle and a second distance between the vehicle and a rear obstacle. Moreover, the operating modes of the first image camera unit and the second image camera unit are automatically adjusted by the first camera control unit and the second camera control unit according to the first distance and the second distance. An auxiliary image corresponding to the operating mode is displayed on the display device for assisting the driver to reverse and park the vehicle. According to the auxiliary image, the driver can estimate the distances of the vehicle from the front obstacle and/or rear obstacle. Consequently, the possibility of causing collision or accident will be minimized. Moreover, according to the vehicle operating parameters (i.e., the gear shift changing information and the gear shift retention time period), the timing of enabling the first image camera unit and the second image camera unit can be determined. Consequently, the driver can accurately realize the condition in front of the vehicle and the condition behind the vehicle. Even if the vehicle encounters the traffic congestion, the misjudgment of the vehicle-reversing image capture device will be largely reduced. In other words, the vehicle-reversing image capture device of the present invention is intelligent and user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A vehicle-reversing display system capable of automatically switching multiple field-of-view modes by image object detection, comprising:
a controller area network providing plural vehicle-reversing parameters;
a vehicle-reversing image capture device comprising:
a first image camera unit comprising a first camera control unit and a first sensor, wherein the first sensor captures the image and the first camera control unit recognizes a first distance between the first image camera unit and a first obstacle;
a second image camera unit comprising a second image camera unit and a second sensor, wherein the second sensor captures the image and the second camera control unit recognizes a second distance between the second image camera unit and a second obstacle; and
a controlling unit connected with the first image camera unit, the second image camera unit and the controller area network, wherein the controlling unit judges a driving scenario of a vehicle according to the plural vehicle-reversing parameters from the controller area network, and the first image camera unit and the second image camera unit are automatically and selectively enabled or disabled according to the driving scenario, wherein the first image camera unit and the second image camera unit are automatically operated in a wide field-of-view mode, a normal field-of-view mode, or a top field-of-view mode under control of the first camera control unit and the second camera control unit according to the first distance and the second distance, respectively; and
a display device connected with the vehicle-reversing image capture device, wherein an auxiliary image corresponding to the wide field-of-view mode, the normal field-of-view mode, or the top field-of-view mode is captured by the first image camera unit or the second image camera unit and displayed on the display device.

2. The vehicle-reversing display system according to claim 1, wherein the vehicle operating parameters include a gear shift changing information and a gear shift retention time period.

3. The vehicle-reversing display system according to claim 1, wherein if the gear shift changing information indicates that a gear shift of the vehicle is changed from a non-reverse gear shift to a reverse gear shift, the controlling unit judges that the driving scenario of the vehicle is a first scenario, wherein in the first scenario, the first image camera unit and the second image camera unit are both enabled.

4. The vehicle-reversing display system according to claim 1, wherein if the gear shift changing information indicates that a gear shift of the vehicle is changed from a reverse gear shift to a non-reverse gear shift, the controlling unit judges that the driving scenario of the vehicle is a second scenario, wherein in the second scenario, the first image camera unit is enabled, but the second image camera unit is disabled.

5. The vehicle-reversing display system according to claim 1, wherein if the gear shift changing information indicates that a gear shift of the vehicle is changed from a reverse gear shift to a non-reverse gear shift and the gear shift retention time period exceeds a threshold time, the controlling unit judges that the driving scenario of the vehicle is a third scenario, wherein in the third scenario, the first image camera unit and the second image camera unit are both disabled.

6. The vehicle-reversing display system according to claim 1, wherein if the first distance is longer than 1.5 m and the first image camera unit is enabled, the first image camera unit is switched to the wide field-of-view mode, wherein if the second distance is longer than 1.5 m and the second image camera unit is enabled, the second image camera unit is switched to the wide field-of-view mode.

7. The vehicle-reversing display system according to claim 1, wherein if the first distance is in a range between 0.4 and 1.5 m and the first image camera unit is enabled, the first image camera unit is switched to the normal field-of-view mode, wherein if the second distance is in a range between 0.4 and 1.5 m and the second image camera unit is enabled, the second image camera unit is switched to the normal field-of-view mode.

8. The vehicle-reversing display system according to claim 1, wherein if the first distance is shorter than 0.4 m and the first image camera unit is enabled, the first image camera unit is switched to the top field-of-view mode, wherein if the second distance is shorter than 0.4 m and the second image camera unit is enabled, the second image camera unit is switched to the top field-of-view mode.

9. The vehicle-reversing display system according to claim 1, wherein a horizontal viewing angle in the wide field-of-view mode is in a range between 170 and 190 degrees, a horizontal viewing angle in the normal field-of-view mode is in a range between 110 and 150 degrees, and a horizontal viewing angle in the top field-of-view mode is in a range between 60 and 90 degrees.

10. The vehicle-reversing display system according to claim 1, wherein the first image camera unit and the second image camera unit are connected with the display device, respectively.

11. A vehicle-reversing image capture device of a vehicle-reversing display system, the vehicle-reversing display system comprising a controller area network and a display device, the vehicle-reversing image capture device comprising:
a first image camera unit comprising a first camera control unit and a first sensor, wherein the first sensor captures the image and the first camera control unit recognizes a first distance between the first image camera unit and a first obstacle;
a second image camera unit comprising a second camera control unit and a second sensor, wherein the second sensor captures the image and the second camera control unit recognizes a second distance between the second image camera unit and a second obstacle; and
a controlling unit connected with the first image camera unit, the second image camera unit and the controller area network, wherein the controlling unit judges a driving scenario of a vehicle according to the plural vehicle-reversing parameters from the controller area network, and the first image camera unit and the second image camera unit are automatically and selectively enabled or disabled according to the driving scenario, wherein the first image camera unit and the second image camera unit are automatically operated in a wide field-of-view mode, a normal field-of-view mode, or a top field-of-view mode under control of the first camera control unit and the second camera control unit according to the first distance and the second distance, wherein an auxiliary image corresponding to the wide field-of-view mode, the normal field-of-view mode, or the top field-of-view mode is captured by the first image camera unit or the second image camera unit and displayed on the display device.

12. The vehicle-reversing image capture device according to claim 11, wherein the vehicle operating parameters include a gear shift changing information and a gear shift retention time period.

13. The vehicle-reversing image capture device according to claim 11, wherein if the gear shift changing information indicates that a gear shift of the vehicle is changed from a non-reverse gear shift to a reverse gear shift, the controlling unit judges that the driving scenario of the vehicle is a first scenario, wherein in the first scenario, the first image camera unit and the second image camera unit are both enabled.

14. The vehicle-reversing image capture device according to claim 11, wherein if the gear shift changing information indicates that a gear shift of the vehicle is changed from a reverse gear shift to a non-reverse gear shift, the controlling unit judges that the driving scenario of the vehicle is a second scenario, wherein in the second scenario, the first image camera unit is enabled, but the second image camera unit is disabled.

15. The vehicle-reversing image capture device according to claim 11, wherein if the gear shift changing information indicates that a gear shift of the vehicle is changed from a reverse gear shift to a non-reverse gear shift and the gear shift retention time period exceeds a threshold time, the controlling unit judges that the driving scenario of the vehicle is a third scenario, wherein in the third scenario, the first image camera unit and the second image camera unit are both disabled.

16. The vehicle-reversing image capture device according to claim 11, wherein if the first distance is longer than 1.5 m and the first image camera unit is enabled, the first image camera unit is switched to the wide field-of-view mode, wherein if the second distance is longer than 1.5 m and the second image camera unit is enabled, the second image camera unit is switched to the wide field-of-view mode.

17. The vehicle-reversing image capture device according to claim 11, wherein if the first distance is in a range between 0.4 and 1.5 m and the first image camera unit is enabled, the first image camera unit is switched to the normal field-of-view mode, wherein if the second distance is in a range between 0.4 and 1.5 m and the second image camera unit is enabled, the second image camera unit is switched to the normal field-of-view mode.

18. The vehicle-reversing image capture device according to claim 11, wherein if the first distance is shorter than 0.4 m and the first image camera unit is enabled, the first image camera unit is switched to the top field-of-view mode, wherein if the second distance is shorter than 0.4 m and the second image camera unit is enabled, the second image camera unit is switched to the top field-of-view mode.

19. The vehicle-reversing image capture device according to claim 11, wherein a horizontal viewing angle in the wide field-of-view mode is in a range between 170 and 190 degrees, a horizontal viewing angle in the normal field-of-view mode is in a range between 110 and 150 degrees, and a horizontal viewing angle in the top field-of-view mode is in a range between 60 and 90 degrees.

20. The vehicle-reversing image capture device according to claim 11, wherein the first image camera unit and the second image camera unit are connected with the display device, respectively.
